(19) United States
(12) Patent Application Publication
(10) Pub. No.: US 2014/0159673 A1
(43) Pub. Date: Jun. 12, 2014

(54) WIRELESS CHARGING APPARATUS AND METHOD

(71) Applicant: Samsung Electronics Co., Ltd., Gyeonggi-do (KR)

(72) Inventors: Seung-Woo HAN, Seoul (KR); Yu-Su Kim, Gyeonggi-do (KR); Woo-Ram Lee, Gyeonggi-do (KR); Ho-Seong Lee, Gyeonggi-do (KR)

(73) Assignee: Samsung Electronics Co., Ltd., Gyeonggi-do (KR)

(21) Appl. No.: 14/100,866

(22) Filed: Dec. 9, 2013

(30) Foreign Application Priority Data
Dec. 7, 2012 (KR) 10-2012-0142109
Aug. 28, 2013 (KR) 10-2013-0102589

(51) Int. Cl. H02J 7/02

(52) U.S. Cl. CPC H02J 7/025
USPC 320/137; 307/104

(57) ABSTRACT

A wireless charging method includes receiving information on a required amount of power from a second wireless power receiver while supplying power to one or more first wireless power receivers; calculating required power for all wireless power receivers including the one or more first wireless power receivers and the second wireless power receiver; and when a maximum amount of providable power is not larger than the required amount of power for all wireless power receivers, transmitting insufficient power amount information to each of the wireless power receivers.

### PRIORITY

This application claims priority under 35 U.S.C. §119(a) to Korean Patent Application Serial Nos. 10-2012-0142109 and 10-2013-0102589, filed in the Korean Intellectual Property Office on Dec. 7, 2012 and Aug. 28, 2013, respectively, the entire content of each of which are incorporated herein by reference.

### BACKGROUND OF THE INVENTION

1. Field of Invention

The present invention relates generally to a wireless charging technology.

2. Description of Related Art

Mobile terminals, such as mobile phones, Personal Digital Assistants (PDA) and the like, are often powered by rechargeable batteries. Electrical energy is supplied to the battery of the mobile terminal through a separate charging apparatus used to charge the battery. In general, separate contact terminals are arranged outside of the charging apparatus and the battery, and the charging apparatus and the battery are electrically connected to each other through contact between the contact terminals.

However, since the contact terminals protrude outward in such contact type charging schemes, the contact terminal is easily contaminated by foreign substances and thus the battery charging may not be correctly performed. Further, the battery charging may also not be correctly performed in cases where the contact terminal is exposed to moisture.

In order to solve the above-mentioned problem, a wireless charging or a non-contact charging technology has been developed and is currently used for many electronic devices.

The wireless charging technology allows for wireless power transmission/reception, and may be used, for example, in a system capable of automatically charging a battery by putting a mobile phone on a charging pad without any connection through a separate charging connector. In general, this wireless charging technology is known commercially by its application in devices such as cordless electric toothbrushes and cordless electric shavers. Accordingly, the wireless charging technology can improve a waterproofing function through wireless charging of electronic products, and increase a portability of electronic devices since there is no need to provide a wired charging apparatus. Therefore, technologies related to the wireless charging technology are expected to be significantly developed in the coming age of electric cars.

The wireless charging technology principally includes an electromagnetic induction scheme using a coil, a resonance scheme using a resonance, and an (Radio Frequency) RF/microwave radiation scheme converting electrical energy to a microwave and then transmitting the microwave energy.

Though the electromagnetic induction scheme is not yet completely mainstream, recent successful experiments for transmitting power wirelessly to destinations spaced apart by dozens of meters through the use of microwaves makes it likely that in the near future many electronic products will be charged wirelessly.

A power transmission method through the electromagnetic induction corresponds to a scheme of transmitting power between a first coil and a second coil. A transmission side generates a magnetic field by using the induced current generated by moving a magnet on the coil and a reception side generates energy through an induced current according to changes in the magnetic field. The phenomenon is referred to as ‘magnetic induction’, and the power transmission method using magnetic induction has a high energy transmission efficiency.

A system has recently been developed in which electricity is wirelessly transferred using a power transmission principle of the resonance scheme even when a device to be charged is separated from a charging device by several meters. This system, based on the “Coupled Mode Theory”, employs a concept in physics whereby a device or a system can be modeled as a coupled resonator, such as when a tuning fork oscillates at a particular frequency and a wine glass next to the tuning fork oscillates at the same frequency. An electromagnetic wave containing electrical energy instead of resonating sounds is resonated, and the resonated electrical energy is directly transferred only when there is a device having a resonance frequency. Parts of the electrical energy which are not used are reabsorbed into an electromagnetic field instead of being spread in the air, so that the electrical energy does not affect surrounding machines or people unlike other electromagnetic waves. For example, when the wireless power transmission technology is used for the wireless charging system, the wireless charging system may include a wireless power transmitter that transmits power and a wireless power receiver that charges a battery with power. The wireless power transmitter transmits power required for the charging and supplies the power to an object. The wireless power receiver may perform the charging by using the transmitted power. Recently, a multi-charging system was developed and used in which a plurality of wireless power receivers received power from one wireless power transmitter to perform the charging. However, in a conventional wireless charging system, while required power amounts vary depending on the number of wireless power receivers, power amounts supplied by a wireless power transmitter are fixed as constant power amounts, so that power cannot be efficiently supplied.

For example, the wireless power transmitter in the conventional wireless charging system uses a single antenna. Accordingly, if maximum transmission power is fixed, power cannot be efficiently supplied.

Further, since the fixed maximum transmission power of the wireless power transmitter cannot be changed even though the wireless power transmitter uses a power tracking function, problems may occur when the number of wireless power receivers increases.

### SUMMARY

The present invention has been made to address at least the problems and disadvantages described above, and to provide at least the advantages described below.

Accordingly, an aspect of the present invention is to provide a wireless charging apparatus and method capable of efficiently performing a charging function even though the number of wireless power receivers increases.

In accordance with an aspect of the present invention, a wireless charging method is provided. The wireless charging method includes receiving information on a required amount of power from a second wireless power receiver while supplying power to one or more first wireless power receivers; calculating the required amount of power for all wireless power receivers including the one or more first wireless power receivers and the second wireless power receiver; and when a maximum amount of providable power is not larger than the required amount of power for all wireless power receivers, transmitting insufficient power amount information to each of the wireless power receivers.

In accordance with another aspect of the present invention, a wireless charging method is provided. The wireless charging method includes transmitting information on a required amount of power to a wireless power transmitter; receiving insufficient power amount information from the wireless power transmitter; and changing a charging current value by using the insufficient power amount information.

In accordance with another aspect of the present invention, a wireless power transmitter is provided. The wireless power transmitter includes a power transmitter that transmits wireless power; a communication unit that receives information on required power from a second wireless power receiver while transmitting power to one or more first wireless power receivers; and a controller that calculates a required amount of power for all wireless power receivers including the one or more first wireless power receivers and the second wireless power receiver, and controls to transmit insufficient power amount information to each of the wireless power receivers when a maximum amount of providable power is not larger than the required amount of power for all wireless power receivers.

In accordance with another aspect of the present invention, a wireless power receiver is provided. The wireless power receiver includes a power receiver that receives wireless power from a wireless power transmitter to perform charging; a communication unit that performs transmission/reception with the wireless power transmitter; and a controller that controls to transmit information on a required amount of power to the wireless power transmitter, and controls to change a charging current value of the wireless power receiver by using insufficient power amount information when the insufficient power amount information is received from the wireless power transmitter.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram of a wireless charging system according to an embodiment of the present invention;

FIG. 2 is a flowchart illustrating a general operation of a wireless charging system according to an embodiment of the present invention;

FIG. 3 is a block diagram of a wireless power transmitter and a wireless power receiver according to an embodiment of the present invention;

FIG. 4 is a block diagram of a wireless power transmitter and a wireless power receiver according to an embodiment of the present invention;

FIG. 5 is a flowchart illustrating an operation of a wireless power transmitter according to an embodiment of the present invention; and

FIG. 6 is a flowchart illustrating an operation of a wireless power receiver according to another embodiment of the present invention.

### DETAILED DESCRIPTION OF EMBODIMENTS OF THE PRESENT INVENTION

Hereinafter, various embodiments of the present invention will be described more specifically with reference to the accompanying drawings. This invention may, however, be embodied in many different forms and should not be construed as limited to the embodiments set forth herein. Rather, these embodiments are provided so that the description of this invention will be thorough and complete, and will fully convey the scope of the invention to those skilled in the art. The present invention will be defined by the appended claims.

It should be noted that the same components of the drawings are designated by the same or similar reference symbols throughout the drawings. In the following description of the present invention, a detailed description of well-known functions and configurations incorporated herein will be omitted when it may make the subject matter of the present invention unclear.

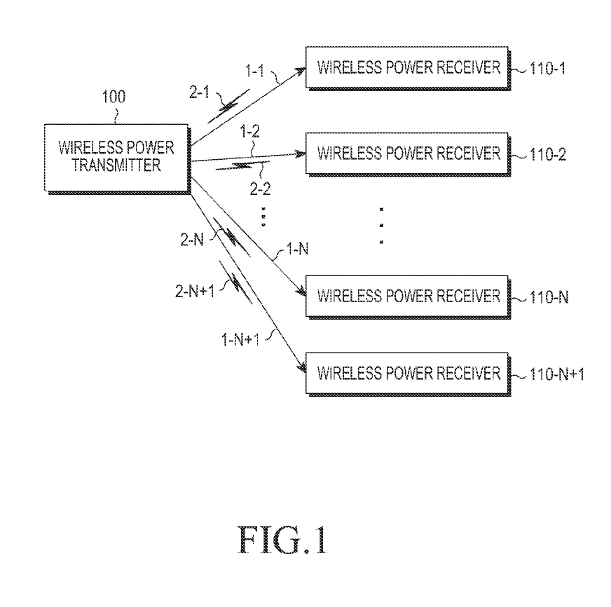

FIG. 1 illustrates a block diagram of a wireless charging system according to an embodiment of the present invention. Referring to FIG. 1, the wireless charging system may include a wireless power transmitter 100 and one or more wireless power receivers 110-1, 110-2, . . . , 110-N, and 110-N+1.

The wireless power transmitter 100 may wirelessly transmit power 1-1, 1-2, . . . , 1-N, and 1-N+1 to the one or more wireless power receivers 110-1, 110-2, . . . , 110-N, and 110-N+1, respectively. More specifically, the wireless power transmitter 100 may wirelessly transmit power to wireless power receivers which have been authenticated through a predetermined authentication procedure.

The wireless power transmitter 100 may form electrical connections with the wireless power receivers 110-1, 110-2, . . . , 110-N, and 110-N+1. For example, the wireless power transmitter 100 may transmit wireless power in an electromagnetic wave form to the wireless power receivers 110-1, 110-2, . . . , 110-N, and 110-N+1.

Additionally, the wireless power transmitter 100 may perform bi-directional communication with the wireless power receivers 110-1, 110-2, . . . , 110-N, and 110-N+1. The wireless power transmitter 100 and the wireless power receivers 110-1, 110-2, . . . , 110-N, and 110-N+1 may process or transmit/receive packets 2-1, 2-2, . . . , 2-N, and 2-N+1 including predetermined frames. The wireless power receiver may be implemented by a mobile communication terminal, a Personal Digital Assistant (PDA), a Portable Multimedia Player (PMP), a smart phone or the like.

The wireless power transmitter 100 may wirelessly provide power to a plurality of wireless power receivers 110-1, 110-2, . . . , 110-N, and 110-N+1. For example, the wireless power transmitter 100 may transmit power to the plurality of wireless power receivers 110-1, 110-2, . . . , 110-N, and 110-N+1 using the resonance scheme. When the wireless power transmitter 100 adopts the resonance scheme, it is preferable that distances between the transmitter 100 and the wireless power receivers 110-1, 110-2, . . . , 110-N, and 110-N+1 are 30 meters or shorter. When the wireless power transmitter 100 adopts the electromagnetic induction scheme, it is preferable that distances between the transmitter 100 and the wireless power receivers 110-1, 110-2, . . . , 110-N, and 110-N+1 are 10 centimeters or shorter.

The wireless power receivers 110-1, 110-2, . . . , 110-N, and 110-N+1 may wirelessly receive power from the wireless power transmitter 100 to charge batteries inside the wireless power receivers 110-1, 110-2, . . . , 110-N, and 110-N+1. Further, the wireless power receivers 110-1, 110-2, . . . , 110-N, and 110-N+1 may transmit a signal for requesting wireless power transmission, information required for wireless power reception, state information of the wireless power receiver, or control information of the wireless power transmitter 100 to the wireless power transmitter 100.

The wireless power receivers 110-1, 110-2, . . . , 110-N, and 110-N+1 may transmit messages indicating their charging states to the wireless power transmitter 100.

The wireless power transmitter 100 may include a display means, such as a display, and display a state of each of the wireless power receivers 110-1, 110-2, . . . , 110-N, and 110-N+1 based on the message received from each of the wireless power receivers 110-1, 110-2, . . . , 110-N, and 110-N+1. The wireless power transmitter 100 may also display the estimated time to complete the charging by the wireless power receivers 110-1, 110-2, . . . , 110-N, and 110-N+1.

The wireless power transmitter 100 may transmit a control signal for disabling a wireless charging function to each of the wireless power receivers 110-1, 110-2, . . . , 110-N, and 110-N+1. The wireless power receivers having received the disable control signal of the wireless charging function from the wireless power transmitter 100 may disable the wireless charging function.

According to an embodiment of the present invention, power amounts required for the wireless charging system may vary depending on the number of wireless power receivers. When power amounts supplied to each of the wireless power receivers by the wireless power transmitter 100 are fixed as predetermined power amounts, the power may not be efficiently supplied. For example, when the wireless power transmitter 100 is configured to supply constant power to a maximum of N wireless power receivers 110-1, 110-2, . . . , and 110-N, if there is an additional charging request from a new N+1th wireless power receiver 110-N+1, the power cannot be supplied to the N+1th wireless power receiver 110-N+1.

Accordingly, an embodiment of the present invention intends to provide a wireless charging apparatus and method in which, when there is the additional charging request from the new N+1th wireless power receiver 110-N+1 while the wireless power transmitter 100 supplies power to the N wireless power receivers 110-1, 110-2, . . . , and 110-N, the transmitter 100 can control a power amount supplied to each of the N wireless power receivers 110-1, 110-2, . . . , and 110-N to also supply power to the new wireless power receiver 110-N+1.

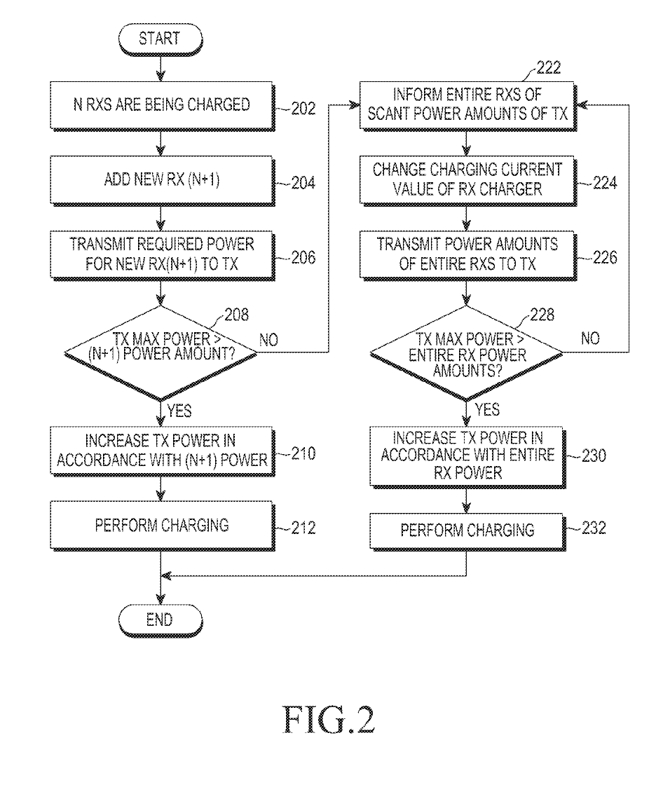

FIG. 2 is a flowchart illustrating a general operation of a wireless charging system according to an embodiment of the present invention. Referring to FIG. 2, when a new wireless power receiver 110-N+1 (New RX) is added in step 204 while the N wireless power receivers 110-1 to 110-N are charged in step 202, information on required power may be transmitted to the wireless power transmitter 100 (Power TX) by the new wireless power receiver 110-N+1 (New RX) in step 206.

The wireless power transmitter 100 may determine whether a maximum amount of providable power (TX max Power) is larger than an amount of power required for the N+1 wireless power receivers 110-1 to 110-N+1 in step 208.

When the maximum of providable power (TX max Power) is larger than the power (N+1 Power amounts) required for the N+1 wireless power receivers 110-1 to 110-N+1, the wireless power transmitter 100 may increase transmission power (TX power) in accordance with the power required for the N+1 wireless power receivers 110-1 to 110-N+1 in step 210. Accordingly, the N+1 wireless power receivers 110-1 to 110-N+1 may receive power to perform charging in step 212.

When the maximum of providable power (TX max Power) is not larger than the power (N+1 Power amounts) required for the N+1 wireless power receivers 110-1 to 110-N+1, the wireless power transmitter 100 may inform all wireless power receivers, for example, the N+1 wireless power receivers 110-1 to 110-N+1, of insufficient power amounts in step 222.

Each of the N+1 wireless power receivers 110-1 to 110-N+1 may change (reduce) a charging current value of a charger (Rx Charger) in accordance with the insufficient power amount in step 224. Further, the N+1 wireless power receivers 110-1 to 110-N+1 may transmit information on required power amounts to the wireless power transmitter 100 according to each of the changed charging power values in step 226.

The wireless power transmitter 100 may determine whether the maximum of providable power (TX max Power) is larger than power (changed power) required for the N+1 wireless power receivers 110-1 to 110-N+1 in step 228.

When the maximum of providable power (TX max Power) is larger than the power (changed power) required for the N+1 wireless power receivers 110-1 to 110-N+1, the wireless power transmitter 100 may increase the transmission power (TX power) in accordance with the power (changed power) required for the N+1 wireless power receivers 110-1 to 110-N+1 in step 230. Accordingly, the N+1 wireless power receivers 110-1 to 110-N+1 may receive power from the wireless power transmitter 100 to perform charging in step 232.

When the maximum of providable power (TX max Power) is not larger than the power (changed power) required for the N+1 wireless power receivers 110-1 to 110-N+1, the wireless power transmitter 100 may return to step 222 to inform all wireless power receivers, for example, the N+1 wireless power receivers 110-1 to 110-N+1, of the insufficient power amounts and repeat steps 222 to 228 until the maximum of providable power (TX max Power) is larger than the power (changed power) required for the N+1 wireless power receivers 110-1 to 110-N+1.

The wireless charging system according to the embodiment of the present invention can provide an efficient power supply when the wireless power transmitter 100 desires to additionally provide power to the new wireless power receiver 110-N+1 while supplying power to the N wireless power receivers 110-1 to 110-N.

Hereinafter configurations of the wireless power transmitter and the wireless power receiver in the wireless charging system according to the embodiment of the present invention as mentioned above will be described in greater detail.

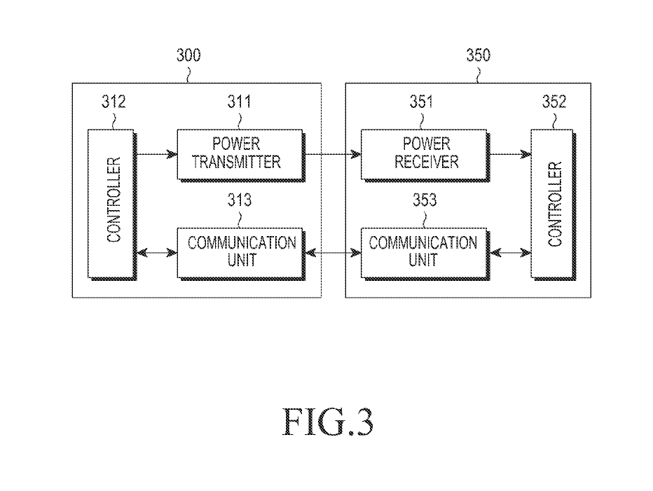

FIG. 3 is a block diagram of the wireless power transmitter and the wireless power receiver according to an embodiment of the present invention. Referring to FIG. 3, a wireless power transmitter 300 may include a power transmitter 311, a controller 312, and a communication unit 313. Further, a wireless power receiver 350 may include a power receiver 351, a controller 352, and a communication unit 353.

The power transmitter 311 may provide power required by the wireless power transmitter 300 and wirelessly provide the power to the wireless power receiver 350. The power transmitter 311 may supply power in an Alternating Current (AC) waveform type, or convert power in a Direct Current (DC) waveform type to power in the AC waveform type, to finally supply the power in the AC waveform type. The power transmitter 311 may be implemented in a form of a built-in battery, or may be implemented in a form of a power reception interface to receive power from the outside and supply the received power to other components. It will be easily understood by those skilled in the art that the power transmitter 311 has no limitation as long as the power transmitter is a means capable of providing constant AC waveform power.

Further, the power transmitter 311 may provide the AC waveform in an electromagnetic wave type to the wireless power receiver 350. The power transmitter 311 may further include a resonant circuit, and accordingly, transmit or receive a predetermined electromagnetic wave. When the power transmitter 311 is implemented by the resonant circuit, inductance L of a loop coil of the resonant circuit may be changed. It will be easily understood by those skilled in the art that the power transmitter 311 has no limitation as long as the power transmitter 311 is a means capable of transmitting/receiving the electromagnetic wave.

The controller 312 may control the general operation of the wireless power transmitter 300 by using an algorithm, a program, or an application, required for the control, read from a storage unit (not shown). The controller 312 may be implemented in a form of a Central Processing Unit (CPU), a microprocessor, or a mini computer. For example, when the controller receives information on required power from a new wireless power receiver (N+1) while supplying power to one or more wireless power receivers (N), the controller 312 may calculate required power for all wireless power receivers including the one or more wireless power receivers (N) and the new wireless power receiver (N+1). At this time, when a maximum amount of providable power is larger than the required amount of power for all wireless power receivers, the controller 312 may control to transmit power in accordance with the required power for all wireless power receivers. Further, when the maximum amount of providable power is not larger than the required amount of power for all wireless power receivers, the controller 312 may control to transmit information on insufficient power amounts to each of the wireless power receivers. When the controller 312 receives information on changed required power from each of the wireless power receivers according to the information on the insufficient power amounts, the controller 312 may control to transmit power in accordance to each of the changed required power for all wireless power receivers.

The communication unit 313 may communicate with the wireless power receiver 350 through a predetermined method. The communication unit 313 may communicate with the communication unit 353 of the wireless power receiver 350 by using Near Field Communication (NFC), ZigBee communication, infrared ray communication, visible ray communication, Bluetooth communication, or Bluetooth Low Energy (BLE). The communication unit 313 may use a CSMA/CA algorithm. It is noted that the above listed communication schemes are only examples, and the scope of embodiments of the present invention is not limited to a particular communication scheme performed by the communication unit 313.

Additionally, the communication unit 313 may transmit a signal for information on the wireless power transmitter 300. The communication unit 313 may unicast, multicast, or broadcast the signal.

Further, the communication unit 313 may receive required power information or changed required power information from the wireless power receiver 350. The power information may include at least one of a charging current value, a capacity, a residual battery quantity, the number of times of charging, a usage quantity, a battery capacity, and a battery ratio of the wireless power receiver 350.

Further, the communication unit 313 may transmit a charging function control signal for controlling a charging function of the wireless power receiver 350. The charging function control signal may be a control signal for enabling or disabling the charging function by controlling the wireless power receiver 351 of a particular wireless power receiver 350.

The communication unit 313 may receive a signal from another wireless power transmitter (not shown) as well as the wireless power receiver 350. For example, the communication unit 313 may receive a notice signal from another wireless power transmitter.

Although it is illustrated in FIG. 3 that the power transmitter 311 and the communication unit 313 are configured by different hardware so that the wireless power transmitter 300 communicates in an out-band type mode, this is only an example. According to the present invention, the power transmitter 311 and the communication unit 313 may be implemented by one piece of hardware so that the wireless power transmitter 300 may communicate in an in-band type mode.

The wireless power transmitter 300 and the wireless power receiver 350 may transmit/receive various types of signals, and accordingly, a process in which the wireless power receiver 350 subscribes to a wireless power network managed by the wireless power transmitter 300 and a charging process through wireless power transmission/reception may be performed.

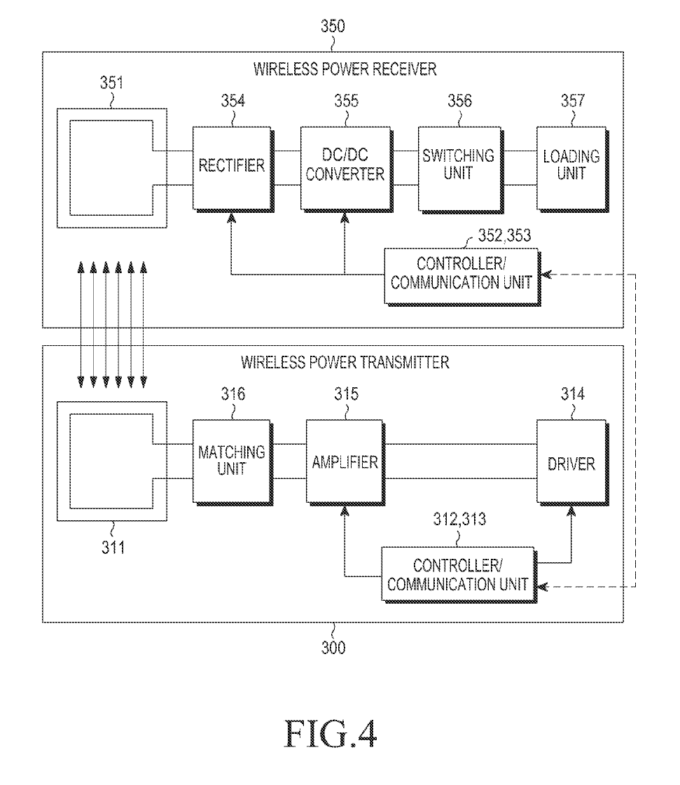

FIG. 4 is a block diagram of the wireless power transmitter and the wireless power receiver according to an embodiment of the present invention. Referring to FIG. 4, the wireless power transmitter 300 may include the power transmitter 311, and the controller/communication unit 312/313, a driver 314, an amplifier 315, and a matching unit 316. The wireless power receiver 350 may include the power receiver 351, the controller/communication unit 352/353, a rectifier 354, a DC/DC converter 355, a switching unit 356, and a loading unit 357.

The driver 314 may output DC power having a preset voltage value. The voltage value of the DC power output from the driver 314 may be controlled by the controller/communication unit 312/313.

The DC power output from the driver 314 may be output to the amplifier 315. The amplifier 315 may amplify the DC power by a preset gain. Further, the amplifier 315 may convert DC power to AC power based on a signal input from the controller/communication unit 312/313. Accordingly, the amplifier 315 may output AC power.

The matching unit 316 may perform impedance matching. For example, the matching unit 316 may adjust impedance viewed from the matching unit 316 to control output power to be high efficiency or high output power. The matching unit 316 may adjust impedance based on a control of the controller/communication unit 312/313. The matching unit 316 may include at least one of a coil and a capacitor. The controller/communication unit 312/313 may control a connection state with at least one of the coil and the capacitor, and accordingly, perform impedance matching.

The power transmitter 311 may transmit input AC power to the power receiver 351. The power transmitter 311 and the power receiver 351 may be implemented by resonant circuits having the same resonance frequency. For example, the resonance frequency may be determined as 6.78 MHz. The power receiver 351 may receive charging power.

The controller/communication unit 312/313 may communicate with the controller/communication unit 352/353 of the wireless power receiver 350, and perform communication (WiFi, ZigBee, or BT/BLE), for example, at a bi-directional 2.4 GHz frequency.

For example, the controller 352 may control to transmit information on required power to the wireless power transmitter 300. The controller 352 may receive charging power transmitted from the power transmitter 300 to perform a control required for the charging. Further, when the controller 352 receives insufficient power amount information from the wireless power transmitter 300, the controller 352 may control to change a charging current value of a charger (Rx Charger) by using the insufficient power amount information (for example, control to reduce the charging current value to a lower value). Further, the controller 352 may control to transmit information on changed required power according to the changed charging current value to the wireless power transmitter 300.

The rectifier 354 may rectify wireless power received by the power receiver 351 to power in a DC type and may be implemented in, for example, a bridge diode type. The DC/DC converter 355 may convert the rectified power by a preset gain. For example, the DC/DC converter 355 may convert the rectified power such that a voltage of an output terminal 359 becomes 5 V. Additionally, a front end 358 of the DC/DC converter 355 may have a preset minimum value and maximum value of the voltage which can be applied.

The switching unit 356 may connect the DC/DC converter 355 and the loading unit 357. The switching unit 356 may maintain an on/off-state according to a control of the controller 352. The loading unit 357 may store the converted power input from the DC/DC converter 356 when the switching unit 355 is in the on-state.

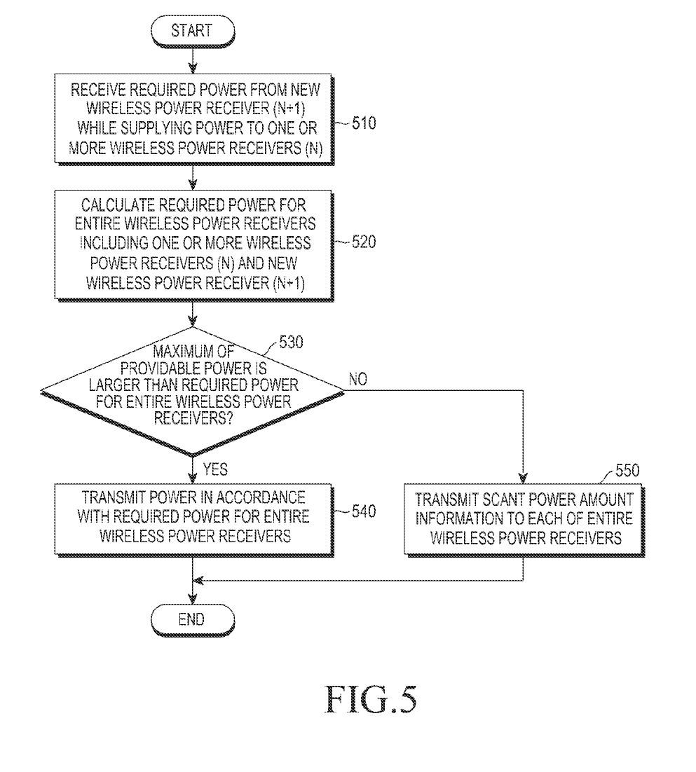

First, FIG. 5 is a flowchart illustrating an operation of the wireless power transmitter 300 according to an embodiment of the present invention. Referring to FIG. 5, the wireless power transmitter 300 may receive information on required power from a new wireless power receiver (N+1) while supplying power to one or more wireless power receivers (N) in step 510.

For example, when the wireless power transmitter 300 receives the information on the required power from the new wireless power receiver (N+1) while supplying power to the one or more wireless power receivers (N), the wireless power transmitter 300 may calculate required power for all wireless power receivers including the one or more wireless power receivers (N) and the new wireless power receiver (N+1) in step 520.

The wireless power transmitter 300 may determine whether a maximum amount of providable power is larger than the required amount of power for all wireless power receivers in step 530.

When the maximum amount of providable power is larger than the required amount of power for all wireless power receivers, the wireless power transmitter 300 may transmit power in accordance with the required amount of power for all wireless power receivers in step 540.

When the maximum amount of providable power is not larger than the required amount of power for all wireless power receivers, the wireless power transmitter 300 may transmit insufficient power amount information to each of the wireless power receivers in step 550.

Each of the wireless power receivers may change a charging current value of a charger (Rx Charger) by using the insufficient power amount information (for example, reduce a charging current value to a lower value). Further, each of the wireless power receivers may transmit again information on changed required power according to the changed charging current value to the wireless power transmitter 300.

The wireless power transmitter 300 may receive the information on the changed required power from each of the wireless power receivers and transmit power to each of the wireless power receivers.

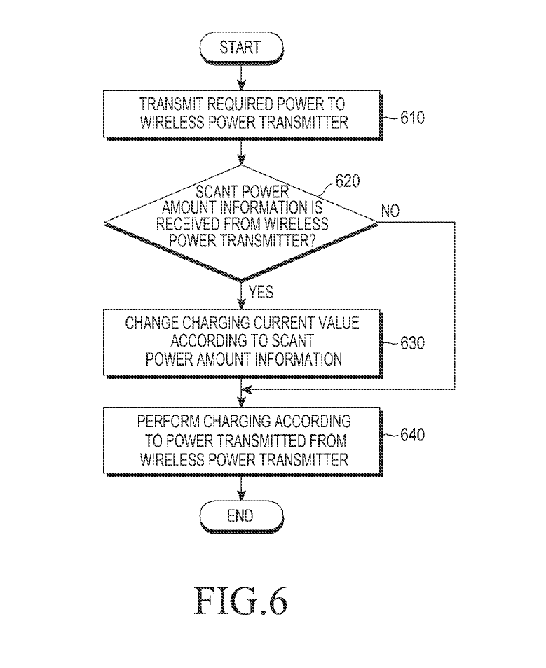

FIG. 6 is a flowchart illustrating an operation of the wireless power receiver 350 according to an embodiment of the present invention. Referring to FIG. 6, the wireless power receiver 350 may transmit information on required power to the wireless power transmitter 300 in step 610.

The wireless power receiver 350 may determine whether insufficient power amount information is received from the wireless power transmitter 300 in step 620.

When the insufficient power amount information is received from the wireless power transmitter 300, the wireless power receiver 350 may control to change a charging current value of a charger (Rx Charger) by using the insufficient power amount information in step 630 (for example, reduce the charging current value to a lower value). Further, the wireless power receiver 350 may transmit information on changed required power according to the changed charging current value to the wireless power transmitter 300.

When the insufficient power amount information is not received from the wireless power transmitter 300, the wireless power receiver 350 may receive power transmitted from the wireless power transmitter 300 to perform the charging function in step 640.

While the present invention has been shown and described with reference to certain embodiments thereof, it will be understood by those skilled in the art that various changes in form and details may be made therein without departing from the spirit and scope of the present invention as defined by the following claims and their equivalents.

What is claimed is:

1. A wireless charging method comprising:
receiving information on a required amount of power from a second wireless power receiver while supplying power to one or more first wireless power receivers;
calculating a required amount of power for all wireless power receivers including the one or more first wireless power receivers and the second wireless power receiver; and
when a maximum amount of providable power is not larger than the required amount of power for all wireless power receivers, transmitting insufficient power amount information to each of the wireless power receivers.

2. The wireless charging method of claim 1, further comprising, when the maximum amount of providable power is larger than the required amount of power for all wireless power receivers, transmitting power to each of the wireless power receivers according to the required power for all wireless power receivers.

3. The wireless charging method of claim 1, further comprising:
receiving information on a changed required amount of power from each of the wireless power receivers according to the insufficient power amount information; and
transmitting power to each of the wireless power receivers according to the changed required amount of power.

4. A wireless charging method comprising:
transmitting information on a required amount of power to a wireless power transmitter;
receiving insufficient power amount information from the wireless power transmitter; and
changing a charging current value by using the insufficient power amount information.

5. The wireless charging method of claim 4, further comprising transmitting information on a changed required amount of power according to the changed charging current value to the wireless power transmitter.

6. The wireless charging method of claim 5, further comprising receiving power transmitted from the wireless power transmitter according to the changed required amount of power to perform charging.

7. A wireless power transmitter comprising:
a power transmitter configured to transmit wireless power;
a communication unit configured to receive information on a required amount of power from a second wireless power receiver while transmitting power to one or more first wireless power receivers; and
a controller configured to calculate a required amount of power for all wireless power receivers including the one or more first wireless power receivers and the second wireless power receiver, and control to transmit insufficient power amount information to each of the wireless power receivers when a maximum amount of providable power is not larger than the required amount of power for all wireless power receivers.

8. The wireless power transmitter of claim 7, wherein, when the maximum amount of providable power is larger than the required amount of power for all wireless power receivers, the controller controls to transmit power to each of the wireless power receivers according to the required amount of power for all wireless power receivers.

9. The wireless power transmitter of claim 7, wherein the communication unit receives information on a changed required amount of power from each of the wireless power receivers according to the insufficient power amount information, and the controller controls to transmit power to each of the wireless power receivers according to the changed required amount of power.

10. A wireless power receiver comprising:
a power receiver configured to receive wireless power from a wireless power transmitter to perform charging;
a communication unit configured to perform transmission/reception with the wireless power transmitter; and
a controller configured to control to transmit information on a required amount of power to the wireless power transmitter, and control to change a charging current value of the wireless power receiver by using insufficient power amount information when the insufficient power amount information is received from the wireless power transmitter.

11. The wireless power receiver of claim 10, wherein the controller controls to transmit information on a changed required amount of power according to the changed charging current value to the wireless power transmitter through the communication unit.

12. The wireless power receiver of claim 10, wherein the controller controls to receive power transmitted from the wireless power transmitter according to a changed required amount of power to perform charging.
